(19) United States
(12) Patent Application Publication
(10) Pub. No.: US 2010/0316244 A1
(43) Pub. Date: Dec. 16, 2010

(54) Earmuff Structure

(76) Inventor: Yueh-Ming Taso, Taipei City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/483,988

(22) Filed: Jun. 12, 2009

(51) Int. Cl. H04R 25/00

(52) U.S. Cl. 381/371

(57) ABSTRACT

An earmuff structure mainly comprises a base having a hole disposed at a center thereof, and the base having a plurality of slide rail grooves disposed at a perimeter thereof, each slide rail groove being assembled with a slot of a click for the click to adjust a distance between the click and the center and to be fixed on the slide rail groove of the base; furthermore, the click having a hooking slant near a front end thereof, the hooking slant connecting to a guiding slant; when the base is to be assembled with a headset, an earphone of the headset is led by the guiding slant of the click to make contact with the hooking slant of the click so as to be held by the elastic force of the click; thereby enlarging a contact area between the user and the headset and to improve sound quality and to ensure personal hygiene.

### BACKGROUND OF THE INVENTION

1. Field of the Invention

The present invention relates to an earmuff structure, and more particularly, to an earmuff structure which can be mounted on any headset in the market to cover the ear in the earmuff without oppressing the ear, thereby improving sound quality and ensuring personal hygiene.

2. Description of the Prior Art

Headsets are often used for activities such as listening to radio or music, watching movies or playing video games in case when a user does not want to disturb others or just wants to enjoy these activities alone.

However, common headsets have the following disadvantages:
1. When the user wears the headset, the earphones of the headset are attached to the user's ears directly, which cause uncomfortable feelings or pains to the ears for long term use of the headset and affect the judgments of the ears to sound reflections.
2. Common headsets are designed with certain specifications and dimensions, which cannot meet the requirements of all customers since the sizes of the ears are different.
3. When a customer wants to listen or sample CDs at a record store, he/she has to use the headset provided by the store and worries about personal hygiene.

Therefore, the above-mentioned traditional headsets present several shortcomings to be overcome.

In view of the above-described deficiencies of traditional headsets, after years of constant effort in research, the inventor of this invention has consequently developed and proposed a new earmuff structure in the present invention.

### SUMMARY OF THE INVENTION

It is an object of the present invention to provide an earmuff structure which can be mounted on an earphone of any headset in the market without oppressing the ear, thereby improving sound quality and providing pleasure in listening.

It is another object of the present invention to provide an earmuff structure which is easy to be assembled with or disengaged from the headset, and it is also easy to carry and easy to store.

It is still another object of the present to provide an earmuff structure which helps to avoid direct contact of the user's ear with the earphone of the headset used in public to ensure personal hygiene.

In order to achieve the above objects, the present invention discloses an earmuff structure, which comprises a base and a plurality of clicks, the base can be in a circular shape or any shape similar to an earphone shape, and the base has a hole disposed at a center and a plurality of slide rail grooves disposed at a perimeter thereof; a wedge is disposed at a bottom of the click and comprises a slot disposed at the middle thereof, a hooking slant extends outwardly from the wedge and connects to a guiding slant at a top end of the hooking slant; wherein the slot of the wedge of the click is to be assembled with the slide rail groove at the perimeter of the base so as to let the plurality of clicks adjust their distances to the center and be fixed on the slide rail grooves on the perimeter of the base to form a holding structure on the perimeter; when the base is to be assembled with a headset, an earphone of the headset is led by the guiding slant of the click to make contact with the hooking slant of the click so as to be held by the elastic force of the click; thereby enlarging a contact area between the user and the headset and to improve sound quality and to ensure personal hygiene.

These features and advantages of the present invention will be fully understood and appreciated from the following detailed description of the accompanying drawings.

### BRIEF DESCRIPTION OF THE DRAWINGS

FIG. 1 illustrates a view of a base of an earmuff structure to be assembled with a click in the present invention;

FIG. 2 illustrates a combinational view of the base of the earmuff structure assembled with a click in the present invention;

FIG. 3A to 3C illustrate operations of the earmuff structure in the present invention; and

FIG. 4 illustrates an implementation of the earmuff structure in the present invention.

### DETAILED DESCRIPTION OF THE PREFERRED EMBODIMENT

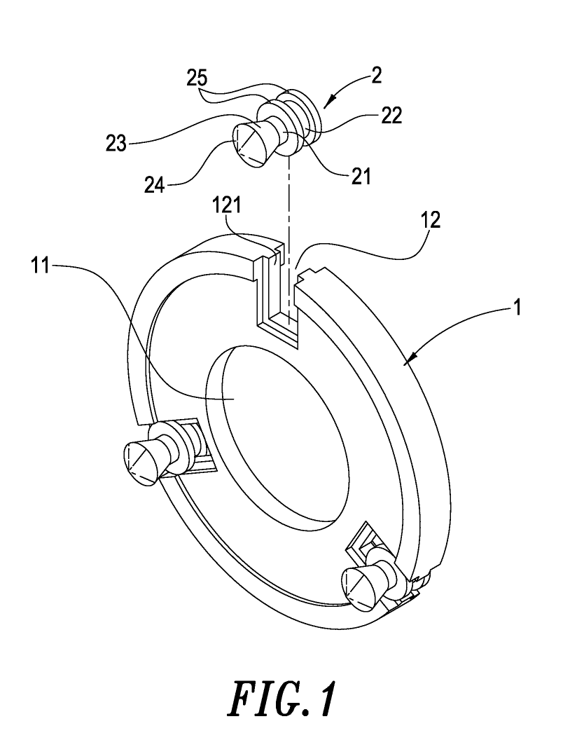

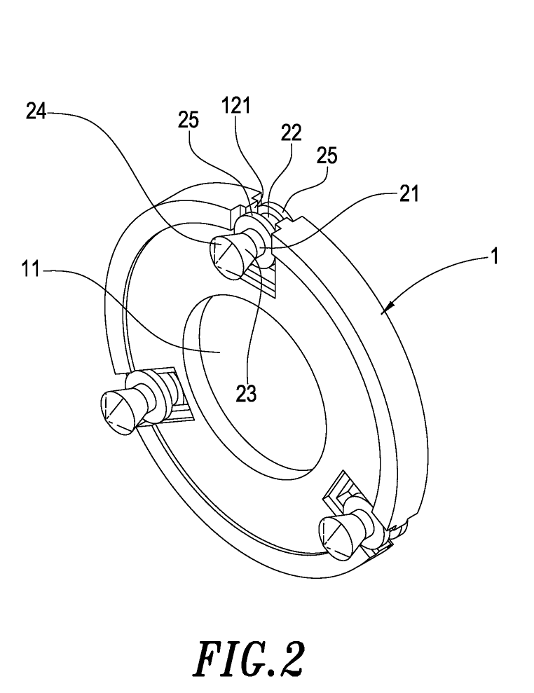

Please refer to FIG. 1 and FIG. 2 for combinational views of a base of an earmuff structure assembled with a click in the present invention, wherein the earmuff structure comprises:
a base 1, the base 1 having a hole 11 disposed at a center thereof, and the base 1 having a plurality of slide rail grooves 12 disposed at a perimeter of the base 1; opposite inner walls of the slide rail grooves are disposed with slide rails 121; besides, the base 1 can be in a circular shape or any shape similar to an earphone shape.

a plurality of clicks 2, each click 2 having a wedge 21 with two tabs 25 extending from the wedge 21 and facing each other to form a slot 22 between them, wherein a hooking slant 23 on the wedge 21 extends outwardly with an increasing diameter to form slightly in a trapezoid shape; a guiding slant 24 extends outwardly from the hooking slant with an decreasing diameter to form slightly in a cone shape at the front end of the click 2; furthermore, the click 2 is made of elastic material.

When the slot 22 of the wedge 21 of the click 2 is to be assembled with the slide rail groove 21 at the perimeter of the base 1, the slot 22 is engaged with the slide rail 121 of the slide rail groove 12 so as to form a holding structure on the perimeter of the base 1; furthermore, since the length of the slide rail groove 12 of the base 1 is longer than the click 2, the click 2 can move up and down in the slide rail groove 12 to adjust a position of the click I in the slide rail groove 21.

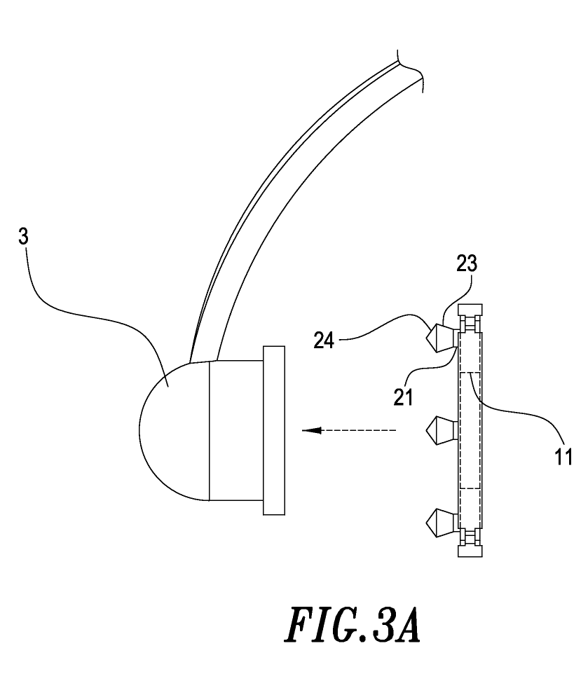

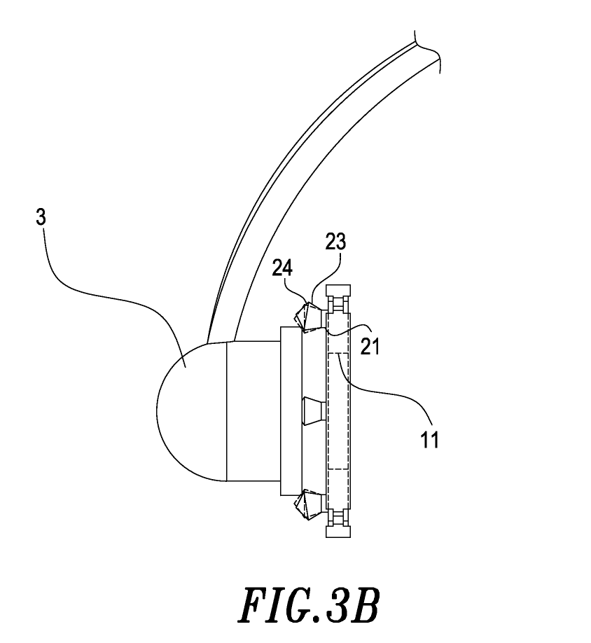

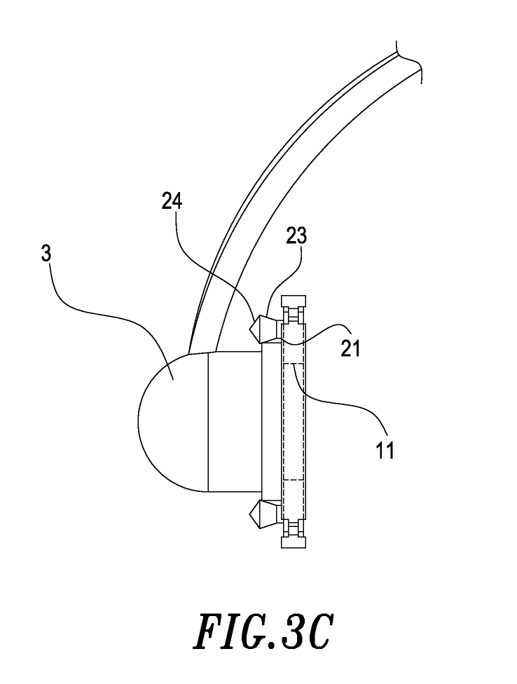

Please refer to FIG. 3A to 3C for operations of the earmuff structure in the present invention. When the base 1 is to be assembled with an earphone 3, the earphone 3 first reaches the guiding slant 24 of the click 2 and is led by the guiding slant 24 to push the click 2 outwardly so as to let the click 2 generate elastic force, then the earphone 3 makes contact with the hooking slant 23 of the click 2 and is held by the elastic force of the click 2; in this manner, the hole 11 of the base 1 corresponds to the speaker of the earphone 3 for facilitating sound output. Therefore, through the combination of the base 1 and the earphone 3, a contact area between the user and the earphone is enlarged, the sound quality is improved, and personal hygiene is ensured.

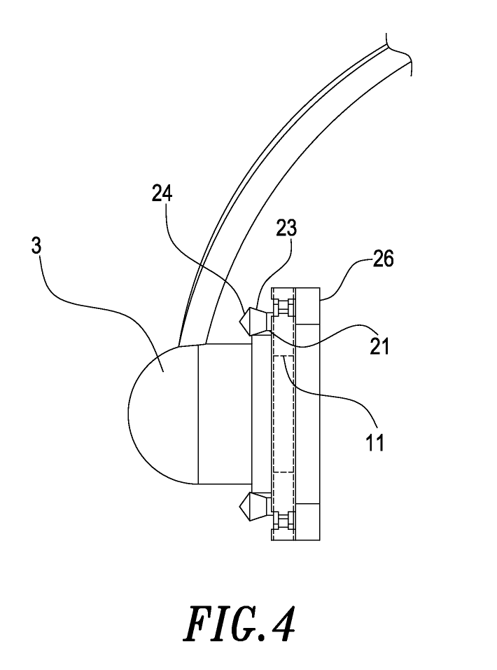

Furthermore, please refer to FIG. 4 for an implementation of the earmuff structure in the present invention. The base 1 can have a surface combined with a pad 26, which is made of foam rubber or other soft materials to provide comfortable wearing experience to the user wearing the earphone 3.

The present invention provides an earmuff structure, while compared with other prior art techniques, is advantageous in:

the present invention provides a removable earmuff structure which can be mounted on an earphone of any headset in the market without oppressing the ear, thereby improving sound quality and providing pleasure in listening;

the present invention provides an earmuff structure which is easy to be assembled with or disengaged from the earphone, and it is also easy to carry and easy to store; and

the present invention provides an earmuff structure which can be mounted on any headsets in the market to help avoid direct contact of the user's ear with the earphone of the headset used in public to ensure personal hygiene.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An earmuff structure comprising:
a base having a hole disposed at a center thereof, and the base having a plurality of slide rail grooves disposed at a perimeter thereof;
a plurality of clicks, each click having a wedge with a slot disposed at a center of the wedge and a hooking slant extending from the wedge, the hooking slant extending to a guiding slant;
wherein the slot of wedge of the click is to be assembled with the slide rail groove at the perimeter of the base so as to let the plurality of clicks be fixed on the slide rail grooves on the perimeter of the base to form a holding structure on the perimeter.

2. The earmuff structure as claimed in claim 1, wherein opposite inner walls of the slide rail grooves are disposed with slide rails, and each one of the slide rails is assembled with the slot of the click to fix the click at the perimeter of the base.

3. The earmuff structure as claimed in claim 1, wherein the base can be in a circular shape or any shape close to an earphone.

4. The earmuff structure as claimed in claim 1, wherein the click is made of elastic material to let the click generate elastic force.

5. The earmuff structure as claimed in claim 1, wherein the base having a surface combined with a pad.

6. The earmuff structure as claimed in claim 1, wherein the hooking slant extends outwardly on the wedge with an increasing diameter of the wedge to form slightly in a trapezoid shape.

7. The earmuff structure as claimed in claim 1, wherein the guiding slant extends outwardly from the hooking slant with an decreasing diameter of the wedge to form slightly in a cone shape.

8. The earmuff structure as claimed in claim 5, wherein the pad can be made of foamed plastic.
